(19) United States
(12) Patent Application Publication
(10) Pub. No.: US 2005/0150315 A1
(43) Pub. Date: Jul. 14, 2005

(54) Internal mechanical wet clutch for agricultural drive systems

(76) Inventor: Jeffrey K. Daniel, Houston, TX (US)

Correspondence Address: Mark A. Tidwell;Jackson Walker L.L.P., Suite 2100, 112 E. Pecan Street, San Antonio, TX, 78205-1521, US

(21) Appl. No.: 10/756,898

(22) Filed: Jan. 14, 2004

(51) Int. Cl. F16H 37/00

(52) U.S. Cl. 74/11

(57) ABSTRACT

An internal, mechanical wet clutch for agricultural equipment is disclosed in which the clutch mechanism is enclosed within a lubricant case filled with oil. The enclosed clutch mechanism is attached to a gearbox for disposition in the driveline of agricultural machinery. The clutch enclosure inhibits tampering with the torque settings of the mechanism and includes an oil bath that functions to lubricate the components of the clutch while at the same time providing a fluid braking that inhibits freewheeling. The enclosures for the gearbox mechanism and clutch mechanism may be completely separate enclosures fastened together, a single enclosure with separate sealed compartments for the gearbox mechanism and the clutch mechanism or a single enclosure with a single compartment enclosing both mechanisms. In one embodiment, the gearbox is a right angle gearbox and is integrally formed with the clutch mechanism.

### BACKGROUND OF THE INVENTION

1. Field of the Invention

The present invention relates to the field ofpower transmission for use in mechanized agricultural equipment, and more particularly to a mechanical clutch incorporated into a drive shaft gear box for agricultural equipment.

2. Description of the Prior Art

It is well known in the prior art to utilize exposed friction clutches to manage the transmission of power from the power take off of a tractor to a piece of agricultural machinery such as irrigation systems, sprayers, sprinklers, mowers, shredders, cutters, tillers, balers, harvesters, seeders, planters and the like. Such clutches provide a torque limiting capability for drive lines on the equipment to protect the various driven components under conditions where excessive amounts of power are required, such as when a machine has plugged with crop. These prior art clutches are generally comprised of an input drive shaft with a drive plate secured thereto and an output drive shaft with a pressure plate mounted thereon to permit axial sliding of the pressure plate along the output shaft, while restraining the pressure plate to rotate in conjunction with the output shaft. A fixed hub or shoulder is also securely attached to the output shaft with a biasing element disposed between the hub and the pressure plate to urge the pressure plate against the drive plate. Typically one or more fasteners mounted on the fixed hub can be adjusted to alter the spring pressure of the biasing element, thereby adjusting the friction between the two plates and the maximum torque that can be passed therebetween. In operation, the clutch will slip if the torque applied to it exceeds the torque transmitting capability of the plates. In normal operation, the fasteners are used to set the maximum operating torque for the particular piece of equipment with which the clutch is used. If the power requirements of the aforementioned machinery exceeds that permitted by the force of the springs, the clutch will slip or otherwise disengage to prevent damage to the tractor or equipment.

One characteristic of these prior art friction clutches is that they are typically not enclosed, such as illustrated in FIG. 1, where there is shown agricultural machinery 10 attached to a tractor 12 and powered by driveline 14 on which is mounted friction clutch 15. Therefore, the clutch plates are exposed to the extreme weather conditions of cold, heat and precipitation that characterize the environments in which agricultural equipment are used and stored. Because of this environment, these clutches have a tendency to rust. This becomes a particular problem when the machinery has been idle for a period of time, such as during the winter season. In such cases, the clutch plates often bond together as they rust. If the degree of rusting is not two severe, the plates can be disengaged by applying a high torque load on the plates to break the plates apart. Otherwise, the plates must be replaced before the clutch is properly operable.

Another characteristic of these prior art clutches is that they are mounted along the driveline to permit easy access to the torque adjustment fasteners, such as is shown in FIG. 1. A drawback to such a configuration is that an operator can easily adjust or “tighten down” the exposed clutch so that the operator will not have to continuously reset the clutch each time a potentially harmful load develops. Such loads are particularly common in the agricultural industry because the terrain on which agricultural equipment is operated is often rocky, uneven and has varying surface conditions, all of which can subject the machinery to high torque. Such harmful loads can also develop as vegetation or crop becomes wrapped around the equipment drive line or other moving parts. In any event, to “override” the safety function of the clutch, operators have been known to tighten the torque adjustment fasteners to an extent that the drive plate and the pressure plate are effectively bolted together, so that the clutch will not disengage once a certain torque is reached. By circumventing the safety benefits of the clutch, these harmful loads can be passed along the drive line, damaging gearboxes and other driveline components, thereby resulting in a much longer down time.

In addition to the drawbacks mentioned above, these exposed clutches of the prior art are subject to tall vegetation, grass and debris that tend to wrap around the exposed clutch and hinder performance. For this reason, several prior art configurations have made attempts to partially or fully enclose the friction clutch. While a fully enclosed friction clutch may prevent tampering such as described above, one result has been a buildup of condensation within the enclosures, thereby causing rust and corrosion of the clutch components. On the other hand, those clutches that are only partially enclosed are subject to torque adjustment tampering as well as dirt and other debris that can hinder performance.

As an alternative to friction clutches, electromechanical clutches have also been utilized in the prior art. Because of the electrical components incorporated in such a clutch, these clutches are generally enclosed. However, the extreme weather conditions of cold, heat and precipitation often result in a buildup of condensation within even an enclosed case. In addition to any resultant rusting to the clutch components, this moisture can cause malfunction of the electrical components of the clutch.

Notwithstanding the foregoing, one of the concerns when utilizing agricultural equipment as described above is that the braking mechanism for the device could become disengaged or that the equipment could become disconnected from the tractor. To the extent equipment is on an incline in such instances, the machinery could roll uncontrolled down the incline with one result being damage to the gearbox as the output shaft freely rotates or “freewheels” within the gearbox.

Thus, it would be desirable to provide a mechanism for agricultural machinery that could protect a driveline gearbox from harmful torque conditions while at the same time functioning to inhibit freewheeling of the output shaft in the gearbox. The device should also discourage tampering with the safety limits of the torque settings, prevent vegetation and other debris from hindering operation of the device, and minimize the likelihood that condensation or similar corrosive buildup could damage the mechanism.

### SUMMARY OF THE INVENTION

These and other objects are achieved through the internal, mechanical wet clutch of the present invention. The clutch is enclosed to inhibit tampering with the torque settings and includes an oil bath that functions to lubricate the components of the clutch while at the same time providing a fluid braking mechanism that inhibits freewheeling. In one embodiment of the invention, the clutch is enclosed within the gearbox casing. In another embodiment, the gearbox of the system is a right angle gearbox that functions to inhibit transmission of uneven loads along the driveline.

The clutch is comprised of an lubricant-filled gearbox in which is mounted a gear mechanism and a clutch mechanism. Since the clutch is enclosed and operates in a wet environment, i.e., the lubricant contained in the gearbox also surrounds the clutch, the rust and corrosion problems of the prior art are avoided. Further, since the clutch is enclosed, it can't be “locked down”. In the event of freewheeling, the lubricant around the clutch inhibits rotation of the output drive shaft, functioning as a fluid brake for the drive shaft. An additional benefit to such a clutch is that the lubricant also dissipates heat generated by the clutch, yielding a longer operational life.

### BRIEF DESCRIPTION OF THE DRAWINGS

FIG. 1 is a side view of a prior art clutch mechanism.

FIG. 2 is a side view of the invention in which a gearbox and enclosed clutch mechanism are shown installed in the driveline of agricultural machinery.

FIG. 3 is a side view of an enclosed clutch attached to a drive line gearbox.

FIG. 4 is a cut-away side view of a right angle internal, wet clutch mechanism of the invention.

### DETAILED DESCRIPTION OF THE PREFERRED EMBODIMENTS

In the detailed description of the invention, like numerals are employed to designate like parts throughout. Various items of equipment, such as fasteners, fittings, etc., may be omitted to simplify the description. However, those skilled in the art will realize that such conventional equipment can be employed as desired.

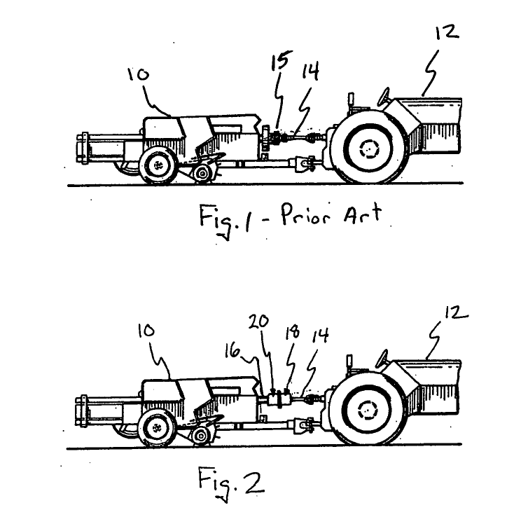

With reference to FIG. 2, agricultural machinery 10 is shown attached to a tractor 12. A power take off driveline 14 extending from tractor 12 is coupled to the input drive shaft 16 of the agricultural equipment 10 via a gearbox 18 and an enclosed mechanical clutch mechanism 20.

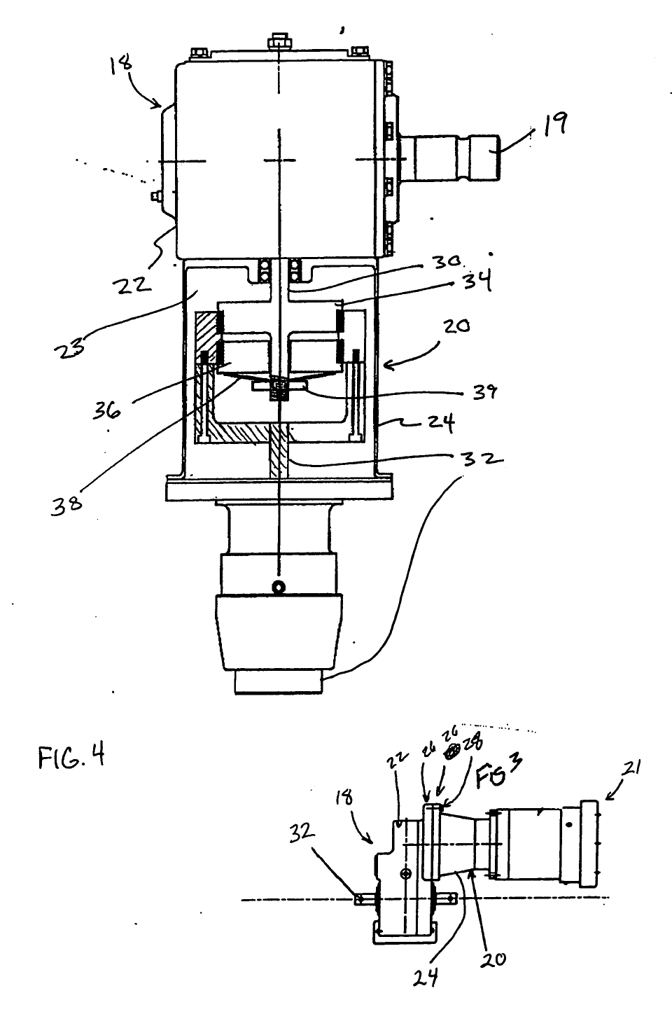

Enclosed clutch mechanism 20 and gearbox 18, also shown with an enclosure, are more particularly shown in FIGS. 3 and 4. Gearbox 18 includes enclosure 22 while clutch mechanism 20 includes enclosure 24. In FIG. 3, enclosures 22, 24 are separate while in FIG. 4 enclosures 22, 24 are more integrally formed. With respect to FIG. 3, although separate enclosures 22, 24 may be attached utilizing any standard means, in the illustrated embodiment, each of enclosures 22 and 24 includes mounting flanges 26 that permit the enclosures to be attached to one another utilizing fasteners 28.

Regardless of the particular enclosure configuration, when gearbox 18 and enclosed clutch mechanism 20 are disposed adjacent one another, an input drive shaft 30 from gearbox 18 is axially aligned with output drive shaft 32 such that drive plate 34 mounted on drive shaft 30 is adjacent pressure plate 36. Biasing element 38 urges plates 34 and 36 into contact with one another. Adjustment nut 39 can be used to adjust the spring pressure of biasing element 38 and hence, the torque limit of clutch mechanism 20. Enclosure 24 is at least partially filled lubricant 23. Likewise, enclosure 22 may also be filled with a lubricant.

As mentioned above, in one preferred embodiment, enclosures 22 and 24 are integrated to form a single enclosure. One benefit to an integrated enclosure such as this is that the gearbox 18 and clutch mechanism 20 can share the same oil bath, thereby reducing maintenance.

The invention is not limited to a particular type of gearbox. In the embodiment illustrated in FIG. 3, gearbox 18 is a parallel shaft divider gearbox, while in FIG. 4, gearbox 18 is a right angle gearbox. In gearbox 18 of FIG. 4, shaft 32 is geared to be driven by gearbox input shaft 19, but where shafts 19 and 32 are in a right angle relationship to one another. In FIG. 3, input shaft 19 (not shown) is parallel with but offset from shaft 32. In FIG. 2, power takeoff driveline 14 is axially aligned with input shaft 19 (not shown) which itself is axially aligned with output shaft 32 (not shown) which is axially aligned with input drive shaft 16. Thus, in the FIG. 2 embodiment, gearbox 18 and enclosed clutch mechanism 20 are axially aligned with one another.

In this same vein, the invention is not limited to a particular arrangement of gearbox 18 and enclosed clutch mechanism 20 with respect to one another. Gearbox 18 may be upstream or downstream of enclosed clutch mechanism 20. Furthermore, power to gearbox 18 may be provided directly from a power takeoff driveline 14 such as is shown in FIG. 2 or from some other power source, such as, without limitation, motor 21 illustrated in FIG. 3.

Likewise, those skilled in the art will understand that the particular type of clutch mechanism does not alter the invention. The clutch mechanism 20 described above is for illustrative purposes only and may include mechanisms used for braking as opposed to torque limiting. What has been described may be referred to as brake or a friction clutch or slip clutch, however, the invention is not limited to these types of mechanisms. Any type of clutch or brake mechanism useful for agricultural machinery could be incorporated within enclosure 24. In addition, the relative locations of the gearbox and clutch mechanism are not limiting. Specifically, the gearbox may be on the upstream or downstream side of clutch mechanism. In this same vein, the terms “output” and “input” to describe various driveline components, and in particular, driveline shafts, are used for convenience purposes only and are not intended to limit the overall inventive concept of an enclosed gearbox mechanism and an oil-filled, enclosed clutch mechanism coupled to one another. Likewise, the gearbox need not be of a particular type and need not be a parallel shaft, divider gearbox, but can include any type of gearbox and gearing configuration.

Furthermore, the type of lubricant filling enclosures 22 and 24 can be any type necessary to meet the needs of the particular operating parameters of the respective mechanism. In one embodiment, the lubricant is heavy machinery oil or gear oil. In another embodiment in which enclosures 22 and 24 are separate, one type of lubricant may be used in enclosure 22 and a different type of lubricant may be used in enclosure 24.

The above described clutch mechanism of the invention thus inhibits persons from interfering with or tampering with the operation of the clutch mechanism and protects the mechanism from becoming entwined with crop or contaminated with other debris common in an agricultural environment. Furthermore, the lubricant extends the operational life of the clutch mechanism both due to the lubricating effects on the clutch mechanism components and by cooling the clutch mechanism components during operation. Finally, in situations where freewheeling could occur, the lubricant around the clutch components inhibits rotation of the drive shafts. Thus, not only does the invention extend the useful life of the driveline components, it has the added safety benefits of protecting the operator and equipment from damage due to torque overloads.

While certain features and embodiments of the invention have been described in detail herein, it will be readily understood that the invention encompasses all modifications and enhancements within the scope and spirit of the following claims.

1. In drive line system for agricultural equipment, said system comprising:
A. A power input shaft;
B. A power output shaft coupled to said power input shaft;
C. Agricultural machinery coupled to said power output shaft and driven by said power output shaft;
D. A gearbox and clutch system disposed between said power input shaft and power output shaft, said clutch system having,
E. A gear mechanism;
F. A clutch mechanism coupled to said gear mechanism;
G. An enclosure enclosing said clutch mechanism; and
H. A lubricant disposed within said clutch mechanism.

2. The system of claim 1, wherein said lubricant substantially fills said enclosure.

3. The system of claim 1, wherein said enclosure is sealed.

4. The system of claim 1, further comprising an enclosure around the gear mechanism.

5. The system of claim 1, wherein said enclosure encloses the gear mechanism and the clutch mechanism.

6. The system of claim 1, wherein said gear mechanism comprises an gear input shaft, a gear output shaft and gears coupling said gear input shaft to said gear output shaft.

7. The system of claim 6, wherein said clutch mechanism comprises a clutch output shaft axially aligned with said gear output shaft, a drive plate disposed on said gear output shaft, a pressure plate disposed on said clutch output shaft adjacent said drive plate, and a biasing element urging said drive plate and said pressure plate into contact with one another.

8. The system of claim 7, wherein said gear input shaft and said gear output shaft are axially offset from one another.

9. A combined gearbox and clutch system for the drive line of agricultural equipment, said gearbox and clutch system comprising:
A. A gear mechanism;
B. A clutch mechanism coupled to said gear mechanism;
C. A clutch enclosure enclosing said clutch mechanism; and
D. A lubricant disposed within said enclosure.

10. The system of claim 9, wherein said lubricant substantially fills said clutch enclosure.

11. The system of claim 9, wherein said clutch enclosure is sealed.

12. The system of claim 9, further comprising an gear enclosure around the gear mechanism.

13. The system of claim 9, wherein said clutch enclosure encloses the gear mechanism and the clutch mechanism.

14. The system of claim 9, wherein said gear mechanism comprises a gear input shaft, a gear output shaft and gears coupling said gear input shaft to said gear output shaft.

15. The system of claim 9, wherein said clutch mechanism comprises a clutch output shaft axially aligned with a clutch input shaft, a drive plate disposed on said clutch input shaft, a pressure plate disposed on said clutch output shaft adjacent said drive plate, and a biasing element urging said drive plate and said pressure plate into contact with one another.

16. The system of claim 9, wherein said lubricant is oil.

17. The system of claim 9 wherein said clutch enclosure encloses the gear mechanism.

18. The system of claim 17, wherein said clutch enclosure defines separate compartments around the gear mechanism and the clutch mechanism.

19. The system of claim 18 wherein said enclosure compartments are sealed from one another.

20. The system of claim 9 wherein said lubricant surrounds said clutch mechanism.

21. The system of claim 9 wherein said lubricant surrounds said clutch mechanism and said gear mechanism.

22. The system of claim 17, wherein said lubricant surrounds said clutch mechanism.

23. The system of claim 19, wherein a lubricant is disposed in each compartment.

24. The system of claim 18, wherein said compartments are in fluid communication with one another.

25. The system of claim 2 wherein the gear mechanism is a right angle gearbox.

26. The system of claim 9, wherein the gear mechanism is a right angle gearbox.

27. The system of claim 9, further comprising a gear enclosure enclosing said gear mechanism, wherein said clutch enclosure is attached to said gear enclosure.

28. A combined gearbox and clutch system for the drive line of agricultural equipment, said gearbox and clutch system comprising:
A. A gearbox;
B. A mechanical, non-electrical clutch coupled to said gearbox,
C. A clutch enclosure enclosing said mechanical clutch; and
D. A machinery oil bath disposed within said enclosure and surrounding said mechanical clutch,
E. Said mechanical clutch comprising a clutch input shaft axially aligned with a clutch output shaft, a drive plate disposed on said clutch input shaft, a pressure plate disposed on said clutch output shaft adjacent said drive plate, and a biasing element urging said drive plate and said pressure plate into contact with one another, wherein said oil bath is in contact with drive plate, pressure plate and biasing element.
